(19) United States
(12) Patent Application Publication
(10) Pub. No.: US 2008/0195427 A1
(43) Pub. Date: Aug. 14, 2008

(54) Rewards Program For Credit Card Issuer

(75) Inventor: Michael J. Hart, Marietta, GA (US)

Correspondence Address: GARDNER GROFF GREENWALD & VILLANUEVA. PC, 2018 POWERS FERRY ROAD, SUITE 800, ATLANTA, GA, 30339, US

(73) Assignee: BREAKAWAY INCENTIVES, LLC, Alpharetta, GA (US)

(21) Appl. No.: 11/916,896

(22) PCT Filed: Jun. 6, 2006
(86) PCT No.: PCT/US2006/021974

§ 371 Date: Dec. 7, 2007

Related U.S. Application Data
(60) Provisional application No. 60/689,483, filed on Jun. 10, 2005.

(51) Int. Cl. G06Q 30/00; G06Q 10/00

(52) U.S. Cl. 705/5; 705/14

(57) ABSTRACT

A method of administering a rewards program for a credit card issuer client of a rewards contractor. The rewards contractor makes arrangements for delivery of a reward to a recipient designated by the credit card issuer, and payment for the reward is made using a credit card issued by the credit card issuer. In this manner, the credit card issuer client receives a revenue stream in the form of the standard transaction rate charged to the vendor of the reward, which can be used to offset a portion of the cost of the rewards program.

### CROSS-REFERENCE TO RELATED APPLICATION

This application claims the benefit of U.S. Provisional Patent Application Ser. No. 60/689,483, filed Jun. 10, 2005, which is hereby incorporated herein by reference in its entirety for all purposes.

### TECHNICAL FIELD

The present invention relates generally to rewards-based incentive programs; and more particularly to a program of delivering travel-related incentive awards to credit cardholders, employees and others by a credit card issuer (“CCI”), wherein payment for the travel is charged to a credit card issued by the CCI, providing a revenue stream for the CCI to recover a portion of the cost of the rewards program.

### BACKGROUND OF THE INVENTION

Businesses or CCI's often give their cardholders and/or employees non-monetary and/or monetary rewards as incentives for spending habits, performance, for recognition of exemplary loyalty, for special occasions, and the like. Customers, service providers, and others may also receive non-monetary and/or monetary rewards from a business or CCI as an incentive to purchase goods or services, to increase business transactions, to increase credit/debit card transactions, to provide exceptional service, to meet critical deadlines, etc. Many of these rewards are in the form of prepaid travel, vacation packages, hotel stays, gift cards, and merchandise. For example, an employee who reaches a pre-determined reward level in a sales contest might receive an all-expense paid weekend trip to New York. In another example, a credit/debit card holder earns 25,000 points/miles on their card rewards program and receives a Free Roundtrip airline ticket anywhere in the domestic 48 states.

Rather than administering rewards programs in-house, many businesses and/or CCI's find it more efficient and effective to engage the services of a third-party rewards contractor. This typically reduces the administrative burden on the business, and may reduce costs considerably due to the rewards contractor's ability to negotiate volume-based discounts on airline tickets, event fees, hotel rooms, rental cars, and the like. The rewards contractor may have full and complete administration of the rewards program points/miles, marketing; call center, redemption processes, and fulfillment. Alternatively, the rewards contractor may only have responsibility for one or more aspects of the rewards program, such as the fulfillment of airline bookings. The business or CCI then allows the employees or cardholders to directly call the rewards contractor for the selection and fulfillment of the rewards item they would like to receive. The order is then taken and any points/miles that should be reduced from their points/miles pool will be removed and the accumulation process continues. All fulfillments would typically go directly to the person(s) who earned the reward from the rewards contractor.

For travel-based rewards, the rewards contractor may utilize the services of an outside travel agent, or may make the arrangements internally through a travel agent global distribution system (“GDS”) booking engine such as Sabre, Worldspan, Amadeus, etc. Such bookings typically require the booking agent to be trained in specialized code entries for the particular booking system. Because of their specialized training, these booking agents often must be more highly compensated than general customer service personnel. Also, the provider typically must settle payments for all travel bookings on a weekly cash basis through the an airline reporting company (“ARC”). There generally is no mechanism for recovering any portion of payments for bookings made in this manner.

While previously known rewards programs have met with differing degrees of success and acceptance in the field, it is recognized that continued innovation and advances are constantly sought by the marketplace. Thus it can be seen that needs exist for improvements to various aspects of rewards programs in general, and travel-based rewards programs in particular. It is to the provision of an improved rewards program meeting these and other needs that the present invention is primarily directed.

### SUMMARY OF THE INVENTION

In example embodiments, the present invention provides an improved business method and system for delivering rewards, such as for example travel-based loyalty rewards by a credit card issuer (“CCI”). In example forms, the system and method of the present invention generate a revenue stream from rewards bookings, enabling a CCI client of a rewards contractor to recover a portion of the overall cost of the rewards program. Example forms of the invention also allow rewards booking by personnel without specialized training in GDS coding, reducing plan administration costs. And example forms of the invention provide a more intuitive, user-friendly interface for program providers and participants, and also facilitate improved monitoring and control of program utilization and costs by the participating company and/or the rewards contractor.

In one aspect, the present invention is a method of administering a rewards program, the method preferably including the steps of issuing a credit card from a credit card issuer; arranging for at least one rewards transaction between a rewards contractor and a reward provider; and making payment for the rewards transaction using the credit card.

In another aspect, the invention is a method of offsetting a portion of the cost of a rewards program for a credit card issuer client of a rewards contractor. The method preferably includes entering an agreement between the rewards contractor and a reward provider for delivery of a reward from a vendor to a recipient designated by the credit card issuer. The method preferably also includes making payment for the reward using a credit card issued by the credit card issuer.

In still another aspect, the invention is a method of administering a rewards program offered by a credit card issuer through a booking agent. The method preferably includes coordinating rewards transactions through the booking agent, and paying for the rewards transactions using a credit card issued by the credit card issuer.

In another aspect, the invention is an apparatus for administering a rewards program, the apparatus including at least one processor for arranging at least one reward transaction between a rewards contractor and a reward provider; and for making electronic payment for the reward transaction using a credit card issued from a credit card issuer, wherein the credit card is used only for the at least one reward transaction.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWING

FIG. 1 shows schematically a loyalty rewards system and method according to an example form of the present invention.

### DETAILED DESCRIPTION OF EXAMPLE EMBODIMENTS

The present invention may be understood more readily by reference to the following detailed description of the invention taken in connection with the accompanying drawing figure, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Many banks, credit unions, brokerage houses, financial advisors, insurers, and other businesses are credit card issuers (“CCI”s). Like many businesses, these CCIs often reward their customers, employees, contractors and others, with incentives for making transactions on credit cards issued by the CCI, for loyalty, performance, etc., through a rewards contractor. For example, a cardholder user of a credit card issued by the CCI may earn “points” or “miles” for dollars spent or transactions made using their credit card, as part of an incentive rewards program offered by the CCI, and those points or miles may be redeemed by the cardholder user for rewards. The rewards may be in the form of travel-based rewards, and/or other forms of non-monetary or monetary awards. A rewards contractor may administer the rewards program for the CCI, and coordinate the transactions between the cardholder user redeeming an award and the vendor providing the reward products or services. Alternatively, the rewards program may be internally administered and the rewards coordinated by the CCI.

CCIs typically receive payment from vendors in the form of a percentage of the transactions made using credit cards issued by the CCI. The typical transaction/interchange rate received by a CCI through this channel ranges between 2 and 3 percent of every card transaction. The CCI typically pays a vendor the full transaction amount, less the transaction rate percentage; and collects the full transaction amount from the card user, thereby generating revenue equal to the transaction rate percentage of each purchase made on a card issued by the CCI.

According to the system and method of the present invention a credit card issuer client of a rewards contractor issues a credit card that is used as the form of payment for the travel bookings related to a rewards program administered by the rewards contractor. This designated credit card issued by the CCI preferably will be used exclusively for all travel bookings made as part of the rewards program. This allows for the CCI to directly monitor and control expenses related to their rewards program. Additionally, it allows the CCI to realize a revenue stream, in the form of their transaction rate percentage, related to all the charges made on the program-specific credit card. This revenue may be used to offset the overall cost of the rewards program, or for other purposes of the business.

The ability for the CCI to recognize the additional revenue from this payment methodology is revolutionary in the rewards industry. Known programs typically rely on the provider settling travel bookings on a weekly cash basis through the Airline Reporting Company. The CCI receives no revenue stream from this standard form of rewards agreement. The rewards contractor can offer the CCI this revenue stream because the rewards contractor is preferably not using one of the usual travel agent booking engines like Sabre, Worldspan, Amadeus, etc., which typically require full cash settlement. Rather, the rewards contractor preferably has an agreement or relationship with a reward provider such as a direct online booking agent (“OBA”) such as for example Orbitz, to bypass the travel agent network, and preferably settles each travel booking at the time of purchase with the credit card issued by the CCI for the rewards program. Direct arrangements are preferably made between the rewards contractor and the reward provider, for example in the form of one or more contracts for volume purchases of rewards such as airfares, hotel stays, rental cars, event tickets, and/or the like, preferably at discounted rates. Alternatively or additionally, arrangements are made between the rewards contractor and one or more vendors of reward components (such as airlines, hotel chains, rental car agencies, etc.), and/or between the reward provider and one or more vendors. The transaction with the OBA preferably includes a private special offer code or other identifier linked with the rewards contractor to access the negotiated discount arrangement in the transaction with the OBA.

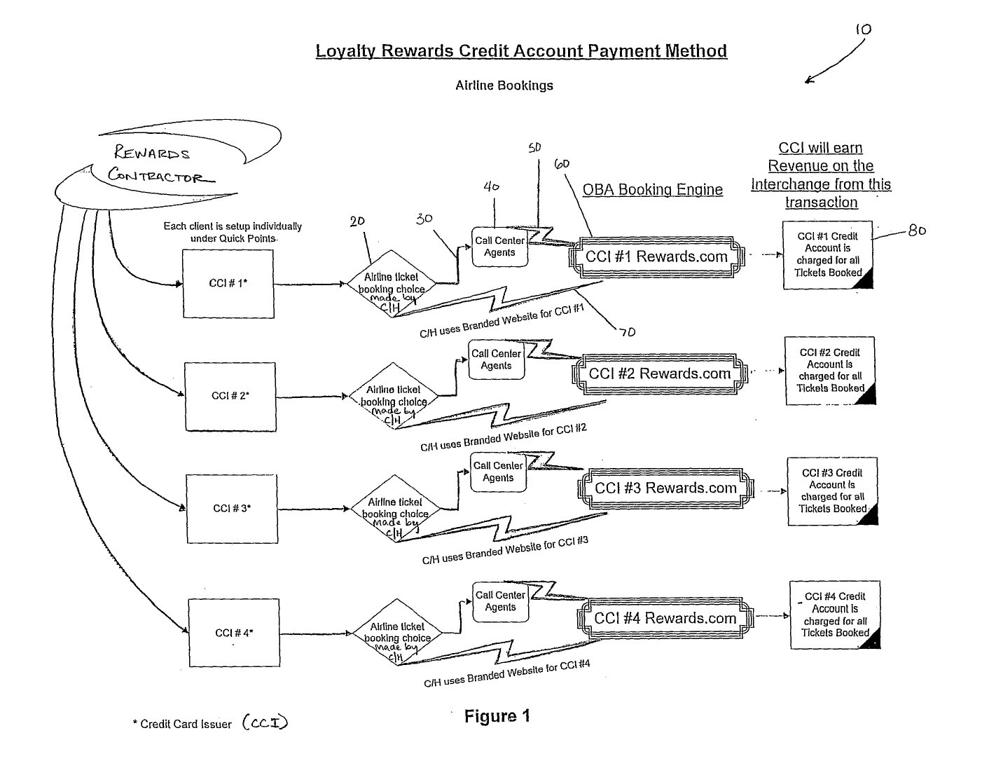

According to the present invention 10, a reward recipient can preferably book a reward component such as an airline ticket by using either of the two methods shown in FIG. 1. Using the first such method, once a customer has made a booking choice 20, a customer can call into the rewards contractor's call center 30, and speak to an agent 40. The agent 40 then books the ticket 50 via the OBA booking engine 60 through a computer network, such as the Internet, or by telephone communication. Using a second method, after a customer has made a booking choice 20, a customer can go online and click thru a link provided by the rewards contractor to access a branded website 70, and use the OBA booking engine 60 directly. In other methods, the customer can directly book their ticket or other rewards incentive by contacting the OBA booking engine 60 by telephone communication. The rewards contractor is issued a credit card account 80 by each CCI and that credit card is used exclusively to book travel for that CCI, whether booked by the rewards contractor or by the recipient through the website administered by the rewards contractor. The OBA preferably allows for the “setup” of various clients within a single business unit. This allows the rewards contractor to setup multiple CCI's.

The OBA agreement preferably allows for all rewards travel to be booked online through the OBA channel. For every booking made on the rewards program, the CCI can recover net revenue generated from the transaction/interchange fees associated with each travel transaction charged to the credit card they have assigned to the program. The travel provider or vendor, i.e., Delta Airlines, Hertz Rent-a-Car, Marriott Hotel, etc. preferably pays the transaction/interchange fees back to the CCI as part of the normal credit card transaction.

This new settlement methodology for the CCI allows for a revenue stream via the transaction/interchange fees to offset a portion of the rewards program costs. Revenues to the CCI will vary depending on the type of credit account used, but standard transaction/interchange rates would be in the range of 2-3 percent. Each CCI preferably then pays the balance on the credit card account with a method agreed to by the rewards contractor and the CCI, or alternatively the rewards contractor pays the credit card balance out of a previously collected program fee.

In example embodiments, the invention also includes a computer-implemented system and apparatus for administering the method described herein. For example, one ore more computers or other processors optionally linked by a network are programmed with computer-readable software to carry out one or more steps of the described method. The invention also includes such computer-readable software and computer-readable media containing such software.

While the invention has been described with reference to preferred and example embodiments, it will be understood by those skilled in the art that a variety of modifications, additions and deletions are within the scope of the invention, as defined by the following claims.

What is claimed is:

1. A method of administering a rewards program, said method comprising issuing a credit card from a credit card issuer; arranging for at least one reward transaction between a rewards contractor and a reward provider; and making payment for the reward transaction using the credit card.

2. The method of claim 1, further comprising delivering a reward to a recipient.

3. The method of claim 2, wherein the credit card issuer designates the recipient.

4. The method of claim 2, wherein the recipient of the reward is a cardholder user of a credit card issued by the credit card issuer, and the reward is earned by making purchases with another credit card issued by the credit card issuer to the cardholder user.

5. The method of claim 1, wherein the credit card issuer receives a percentage of the payment for the rewards transaction.

6. The method of claim 1, wherein the reward is a travel-based reward.

7. The method of claim 6, wherein the travel-based reward is booked through the rewards contractor.

8. The method of claim 6, wherein the travel-based reward is booked by a recipient through a website administered by the rewards contractor.

9. The method of claim 1, wherein the step of arranging for at least one reward transaction between the rewards contractor and the reward provider comprises contracting for volume purchases by the rewards contractor of rewards selected from airfares, hotel stays, rental cars, or event tickets, from the reward provider at discounted rates.

10. A computer-implemented system for carrying out the method of claim 1.

11. Computer readable media containing software for carrying out the method of claim 1.

12. A credit card issued by the credit card issuer for making payment for the reward transaction according to the method of claim 1.

13. A method of offsetting a portion of the cost of a rewards program for a credit card issuer client of a rewards contractor, said method comprising:
entering an agreement between the rewards contractor and a reward provider for delivery of a reward from a vendor to a recipient designated by the credit card issuer; and
making payment for the reward using a credit card issued by the credit card issuer.

14. The method of claim 12, wherein the credit card issuer receives revenue in the form of the standard transaction rate charged to the vendor of the reward.

15. A method of administering a rewards program offered by a credit card issuer through a booking agent, said method comprising coordinating rewards transactions through the booking agent, and paying for the rewards transactions using a first credit card issued by the credit card issuer.

16. The method of claim 15, wherein the rewards are offered to at least one cardholder customer of the credit card issuer as an incentive to make transactions using a second credit card issued by the credit card issuer to the cardholder customer.

17. The method of claim 15, wherein the rewards program is administered by a rewards contractor.

18. The method of claim 15, wherein the rewards program is administered by the credit card issuer.

19. An apparatus for administering a rewards program, said apparatus comprising at least one processor for arranging at least one reward transaction between a rewards contractor and a reward provider; and making electronic payment for the reward transaction using a credit card issued from a credit card issuer, wherein the credit card is used only for said at least one reward transaction.

20. The apparatus of claim 19, wherein the at least one processor electronically credits a percentage of the payment for the at least one reward transaction to the credit card issuer.
